(19) United States
(12) Patent Application Publication
(10) Pub. No.: US 2026/0050752 A1
(43) Pub. Date: Feb. 19, 2026

(54) SYSTEM AND METHOD FOR MULTIPLE LANGUAGE SUBTITLE SYNCHRONIZATION

(71) Applicant: NBCUniversal Media, LLC, New York, NY (US)

(72) Inventor: Jason Rayles, Brookline, MA (US)

(21) Appl. No.: 18/806,110

(22) Filed: Aug. 15, 2024

(51) Int. Cl. G06F 40/58; G06F 3/0484; G06F 40/263; G06F 40/289; G10L 21/055; G11B 27/10

(52) U.S. Cl. CPC G06F 40/58; G06F 40/263; G06F 40/289; G10L 21/055; G11B 27/10; G06F 3/0484

(57) ABSTRACT

A system includes processing circuitry and a memory storing instructions that, when executed by the processing circuitry, causes the processing circuitry to perform operations including retrieving a first file associated with audiovisual content and including a first set of captions, retrieving a second file including a second set of captions, converting the first file into a first set of embeddings and the second file into a second set of embeddings, comparing the first set of embeddings and the second set of embeddings to determine a level of synchronicity between the first file and the audiovisual content, and generating a report based on a level of similarity between the first set of embeddings and the second set of embeddings.

### BACKGROUND

The present disclosure relates generally to subtitles for audiovisual content. More specifically, the present disclosure relates to a system and method for synchronizing multiple language subtitles.

This section is intended to introduce the reader to various aspects of art that may be related to various aspects of the present techniques, which are described and/or claimed below. This discussion is believed to be helpful in providing the reader with background information to facilitate a better understanding of various aspects of the present disclosure. Accordingly, it should be understood that these statements are to be read in this light, and not as admissions of prior art.

Audiovisual content such as movies, television shows, and the like, may incorporate subtitles (i.e., text displayed during playback) in languages other than the content's language of origin for international distribution. For example, a movie or television show with French language audio may include English subtitles available for English-speaking viewers. Traditionally, the process of translating the original language content (e.g., audio) into multi-language subtitles and syncing (e.g., timing) the multi-language subtitles with the original language content is performed manually by human operators. For example, a bilingual or multilingual person fluent in the original language and the foreign language may watch the content and flag inconsistencies in the translation and the syncing of the foreign language subtitles with respect to the original language content. This process may be time-intensive, labor-intensive, and costly, especially for content that requires multiple (e.g., dozens, hundreds) of foreign language subtitles for international distribution. Accordingly, new techniques for multi-language subtitle synchronization by computer processing, independent of human subjective analysis and implementation, may be desirable.

### BRIEF DESCRIPTION

In an aspect, a system includes processing circuitry and a memory storing instructions that, when executed by the processing circuitry, causes the processing circuitry to perform operations including retrieving a first file associated with audiovisual content, where the first file includes a first set of captions, and retrieving a second file including a second set of captions. The first set of captions includes time intervals defining when each caption is to be provided during display of the audiovisual content, and the second set of captions includes time intervals defining when each caption was observed during the audiovisual content. Additionally, the operations include converting the first file into a first set of embeddings and the second file into a second set of embeddings, comparing the first set of embeddings and the second set of embeddings to determine a level of synchronicity between the first file and the audiovisual content, and generating a report based on a level of similarity between the first set of embeddings and the second set of embeddings.

In an aspect, a non-transitory computer-readable medium includes computer readable instructions that, when executed by processing circuitry, causes the processing circuitry to perform operations including retrieving a first file associated with audiovisual content including a first set of captions, and retrieving a second file including a second set of captions. The first and second set of captions include time intervals defining when each caption is provided during display of the audiovisual content. Additionally, the operations include converting the first file into a first set of embeddings and the second file into a second set of embeddings, comparing the first set of embeddings and the second set of embeddings to determine a level of synchronicity between the first file and the audiovisual content, and generating a report based on a level of similarity between the first set of embeddings and the second set of embeddings.

In an aspect, a method includes retrieving a first file including a first set of captions associated with audiovisual content from a first database, and retrieving a second file including a second set of captions from a second database. The first and second set of captions include time intervals defining when each caption is provided during display of the audiovisual content. Additionally, the operations include comparing the first file and the second file to determine a level of similarity between the first set of captions and the second set of captions to determine a level of synchronicity between the first file and the audiovisual content, and generating a report based on a level of similarity between the first set of captions and the second set of captions.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a system for multiple language subtitle synchronization;

FIG. 2 is a block diagram of example components that may be used in the synchronization system of FIG. 1;

FIG. 3 is an example matrix comparing caption file text embeddings and automated speech recognition (ASR) text embeddings;

FIG. 4 is an optimal pathway through the matrix of FIG. 3;

FIG. 5 is a flow chart of a process for multiple language subtitle synchronization;

FIG. 6 is a flow chart of a process for comparing caption file text embeddings and ASR text embeddings; and

FIG. 7 is a block diagram of a graphical user interface of the system of FIG. 1 that may facilitate user interaction with the system of FIG. 1.

### DETAILED DESCRIPTION

One or more aspects of the present disclosure will be described below. In an effort to provide a concise description, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosure.

Aspects of the present disclosure are generally directed towards systems and methods for multi-language subtitle synchronization. For example, a system for multi-language subtitle synchronization may include a synchronization system, a caption database, an automated speech recognition (ASR) database, and a computing device. The synchronization system, caption database, ASR database, and computing device may communicate directly or through a communication network. The communication network may be used to request and send data (e.g., text files, audio files) between the synchronization system, the caption database, the ASR database, and the computing device. The caption database may include caption files with foreign text translations of respective original language content (e.g., audio from movies, television shows, etc.) derived from transcripts, screenplays, commentaries, and the like, of dialog in the original language content. Caption files may also include timings indicating how the foreign text translations align with the timeline of the original language audio. The ASR database may include time-stamped ASR text files with foreign text translations of the respective original language content generated using an Automated Speech Recognition tool (e.g., hardware and/or software).

A caption file may include credible (e.g., substantially accurate) translations of the original language content, with minimal or less credible information related to syncing (e.g., timing) of the foreign language text translations with the original language audio. Conversely, an ASR text file may include credible information related to the timing of the subtitles with less credible translations of the original language content. Accordingly, the presently disclosed systems and methods may employ an automated process to leverage the particularly credible translations in the caption file with the particularly credible syncing (e.g., timing) in the ASR text file.

For example, the synchronization system may utilize natural language processing techniques to extract utterances (e.g., sentences, clauses, phrases, words) from the caption file and the ASR text file, and convert the utterances into text embeddings (e.g., numerical representations of text using multidimensional vectors). The synchronization system may then compare caption file text embeddings against ASR text embeddings to determine numerical values (e.g., geometric measurements such as cosine distance values) indicative of similarities between the caption file and the ASR text file. Further, the synchronization system may use these numerical values to determine if the caption file subtitles are sufficiently synced with the original language audiovisual content (e.g., if the subtitles appear on screen when the respective dialog is being performed). When the caption file subtitles are not sufficiently synced, the synchronization system may recommend changes to the timings of the caption file subtitles (e.g., when the subtitles appear on screen), and/or may flag specific time intervals in the audiovisual content with the caption file subtitles displayed for a user (e.g., human operator) to review. When the caption file subtitles are sufficiently synced, the synchronization system may notify the user that the subtitles are ready to be sent to the next phase in the production process (e.g., formatting for streaming and/or physical releases), and/or may automatically approve the caption file subtitles and send the subtitled audiovisual content to the next phase in the production process.

Accordingly, the presently disclosed techniques may translate original language content into multi-language subtitles and sync the multi-language subtitles with the original language audiovisual content in a more time-efficient, labor-efficient, and cost-efficient manner than traditional methods.

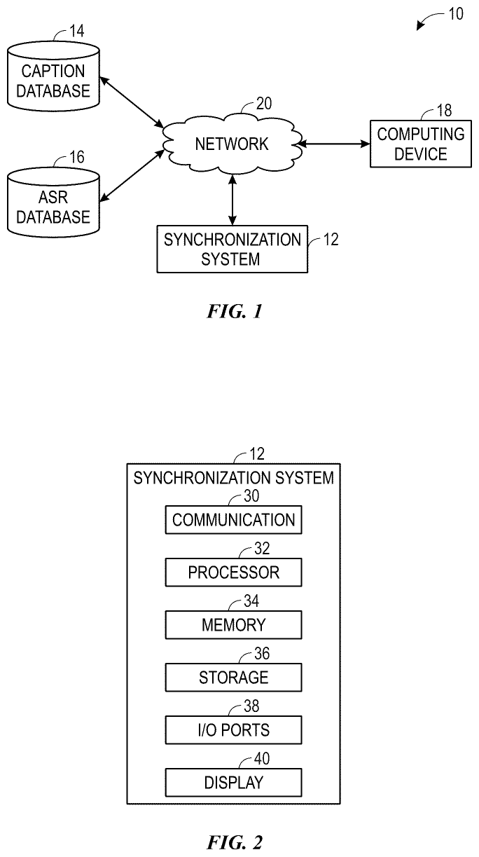

By way of introduction, FIG. 1 is a schematic view of a system 10 for multiple language subtitle synchronization. As illustrated, the system 10 includes a synchronization system 12, a caption database 14, an automated speech recognition (ASR) database 16, and a computing device 18, that may all communicate directly or through a network 20.

The synchronization system 12 may be any suitable computing device that is capable of communicating with other devices and processing data in accordance with the techniques described herein. For example, in certain aspects, the synchronization system 12 may be a cloud-based computing system that includes a number of computers that may be connected through a real-time communication network, such as the Internet. In an aspect, large-scale analysis operations may be distributed over the computers that make up the cloud-based computing system. It should be noted that the synchronization system 12 may also be implemented in a single computing device.

The synchronization system 12 may be communicatively coupled to a caption database 14. For example, the synchronization system 12 may communicate with the caption database 14 directly (e.g., store and access the caption database 14 via one or more suitable memory devices) or through the communication network 20. The caption database 14 may be populated with caption files containing foreign text translations of respective original language content (e.g., audio from movies, television shows, etc.) derived from transcripts, screenplays, commentaries, and the like, of dialog in the original language content. The caption files may be generated using various translation services, such as human translators, verified machine translations (e.g., machine translations reviewed, edited, and approved by humans), and the like. For example, a bilingual person may write English subtitles of a French language film by translating a transcript or screenplay of the French language film, which may be formatted and shared to the caption database 14 as caption files. The caption files may include metadata to categorize the caption files in the caption database 14 and allow specific caption files to be requested or retrieved, such as tags indicating the title of the audiovisual content, the original language of the content, the respective foreign language the content is translated into, and the like. Additionally, the caption files may include metadata such as timestamps indicating when the subtitles should appear on screen. However, the metadata (e.g., timestamps) may be limited as the caption files may be derived using screenplays, scripts, and the like, which may not account for deviations in the recorded dialog (e.g., improvisations from the actors) or stylistic choices (e.g., pauses, musical interludes, etc.). For example, the caption files may include data that indicates when the first subtitle for a scene appears and when the last subtitle for the scene disappears with relative certainty, with extrapolated time intervals (e.g., start and end times) for the remaining subtitles. Accordingly, the caption files may include credible (e.g., substantially accurate) translations of original language content, with minimal or less credible information related to syncing (e.g., timing) of the foreign language text translations with the original language audio.

In certain aspects, the caption database 14 may additionally include caption files that were not generated using translation services or processes. That is, the caption database 14 may include caption files containing text in the original language of the respective audiovisual content, generated directly from scripts, screenplays, commentaries, and the like. These caption files share features of the multi-language caption files (e.g., caption files generated using translation services), in that they may include credible (e.g., substantially accurate) text of dialog within the audiovisual content with minimal or less credible metadata (e.g., timestamps) for the syncing the text.

The synchronization system 12 may also be communicatively coupled, directly or via communication network 20, to an automated speech recognition (ASR) database 16. The ASR database 16 may store time-stamped ASR text files with foreign text translations of original language content generated using an Automated Speech Recognition tool (e.g., hardware and/or software). For example, the Automated Speech Recognition tool may analyze original language content to distinguish human vocal sounds from other sounds in the audio files of audiovisual content (e.g., background noise, soundtrack music), and distinguish specific human vocal sounds from other human vocal sounds to determine which character (e.g., performer) produced which vocals. Accordingly, the Automated Speech Recognition tool may generate text files of dialog from original language content with timestamps for each piece of dialog (i.e., each individual subtitle made up of individual sentences, clauses, etc.) within a threshold degree of accuracy (e.g., 85%, 90%, etc.). The ASR text files may include metadata to categorize the files in the ASR database 16 and allow specific ASR text files to be requested or retrieved, such as tags indicating the title of the audiovisual content, the original language of the content, the respective foreign language the content is translated into, and the like. When the ASR tool is used to generate multi-language subtitles, the extracted text files may be machine translated into the desired language from the original language, while retaining the original timestamps. Accordingly, the ASR text files may include credible (e.g., substantially accurate) information related to the timing of the subtitles with less credible translations of the original language content.

In certain aspects, the ASR database 16 may additionally include ASR text files that were not machine translated. That is, the ASR database 16 may include time-stamped ASR text files generated by deploying the ASR tool on dubbed audiovisual content (e.g., a film with audio files containing original language dialog replaced with audio files containing foreign language dialog) to generate multi-language subtitles, and/or on unaltered original language content to generate time-stamped text files in the original language of the respective content. Regardless of whether the ASR text files are machine translated, they may include credible (e.g., substantially accurate) information related to the timing of subtitles with less credible text of dialog within the audiovisual content.

The synchronization system 12 may retrieve a caption file from the caption database 14 and an ASR text file associated with the same audiovisual content from the ASR database 16 and may employ an automated process to leverage the particularly credible translations in the caption file with the particularly credible syncing (e.g., timing) in the ASR text file. For example, the synchronization system 12 may utilize natural language processing techniques to extract utterances (e.g., sentences, clauses, phrases, words) from the caption file and the ASR text file and convert the utterances into text embeddings (e.g., numerical representations of text using multidimensional vectors). The synchronization system 12 may then compare caption file text embeddings against ASR text embeddings to determine geometric measurements (e.g., cosine distance values) indicative of similarities (e.g., cosine similarities) between the caption file and the ASR text file. Further, the synchronization system 12 may use these geometric measurements to determine if the caption file subtitles are sufficiently synced with the original language audiovisual content (e.g., if the subtitles appear on screen when the respective dialog is being performed).

The synchronization system 12 may communicate with the computing device 18 during the automated process of subtitle synchronization. For example, the synchronization system 12 may send notifications and/or reports to the computing device 18 indicative of the level of synchronicity (e.g., similar timing) between caption file subtitles and ASR text files. When the caption file subtitles are sufficiently synced, the synchronization system 12 may send a notification to the computing device 18 to request user approval to send the subtitles to a next phase in the production process, and/or to indicate that the caption file subtitles were automatically approved and sent to the next phase in the production process. When the caption file subtitles are not sufficiently synced, the synchronization system 12 may send a notification of recommend changes to the timings of the caption file subtitles (e.g., when the subtitles appear on screen) to the computing device 18, and/or may flag specific time intervals for a user (e.g., human operator) to review.

The computing device 18 may be associated with the production and/or distribution of audiovisual content. For example, the computing device 18 may be associated with one or more production companies, film studios, and the like, that oversee the production and distribution of respective audiovisual content. Accordingly, the computing device 18 may populate the caption database 14 and the ASR database 16, and may request the synchronization system 12 to sync and/or confirm the synchronization of a caption file associated with a specific movie, television show, and the like. The computing device 18 may be implemented as one or more computing systems including laptop, notebook, desktop, tablet, HMI, or workstation computers, as well as server type devices or portable, communication type devices, such as cellular telephones and/or other suitable computing devices.

To perform some of the actions set forth above, the synchronization system 12 may include certain components to facilitate these actions. FIG. 2 is a block diagram of example components within the synchronization system 12. For example, the synchronization system 12 may include a communication component 30, a processor 32, a memory 34, a storage component 36, input/output (I/O) ports 50, a display 40, and the like. The communication component 30 may be a wireless or wired communication component that may facilitate communication between the caption database 14, the ASR database 16, the computing device 18, the communication network 20, and the like.

The processor 32 may be any type of suitable computer processor or microprocessor capable of executing computer-executable code. Further, the processor 32 may also include multiple processors that may perform the operations described below. For example, the processor 32 may include general purpose central processing units, application specific processors, and logic devices, as well as any other type of processing circuitry, combinations, or variations thereof. The processor 32 may load and execute software from the memory 34 and/or storage 36.

The memory 34 and the storage 36 may be any suitable articles of manufacture that store processor-executable code, data, or the like. These articles of manufacture may include non-transitory, computer-readable media (e.g., any suitable form of memory or storage) that store the processor-executable code used by the processor 32 to perform the presently disclosed techniques. Examples of memory 34 and storage 36 devices include random-access memory, read-only memory, magnetic disks, optical disks, flash memory, virtual memory and non-virtual memory, as well as any other types of storage media, combinations, or variations thereof. The memory 34 and the storage 36 may also be used to store data, various other software applications, and the like. For example, the memory 34 and the storage 36 may store code for other techniques, in addition to the processor-executable code used by the processor 32 to perform various techniques described herein.

The input/output (I/O) ports 38 may be interfaces that couple to other peripheral components such as input devices (e.g., keyboard, mouse), sensors, input/output (I/O) modules, and the like. The display 40 may operate to depict visualizations associated with software or executable code being processed by the processor 32. In one aspect, the display 40 may be a touch display capable of receiving inputs from a user of the synchronization system 12. The display 40 may be any suitable type of display, such as a liquid crystal display (LCD), plasma display, or an organic light emitting diode (OLED) display, for example. Additionally, in one aspect, the display 40 may be provided in conjunction with a touch-sensitive mechanism (e.g., a touch screen) that may function as part of a control interface for the synchronization system 12. In certain aspects, the synchronization system 12 may not include a display 40. In such aspects, visualizations may be sent by the synchronization system 12 to the computing device 18 for display.

It should be noted that the components described above with regard to the synchronization system 12 are exemplary components and the synchronization system 12 may include additional or fewer components as shown. Additionally, it should be noted that the computing device 18 may also include similar components as described as part of the synchronization system 12.

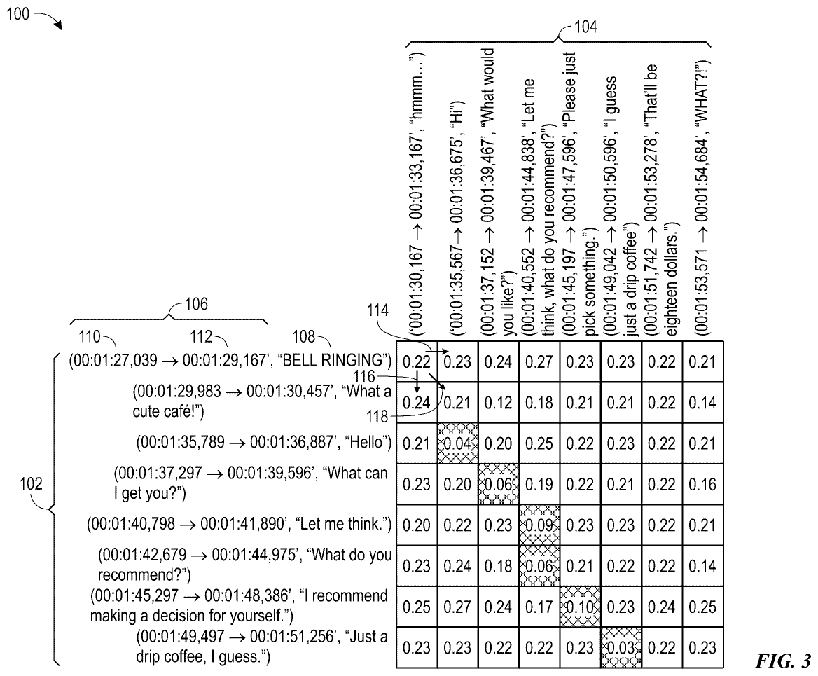

With the foregoing in mind, FIG. 3 is an example matrix 100 comparing caption file text embeddings 102 and automated speech recognition (ASR) text embeddings 104. Although the following description of the system and method are described as generating the matrix 100 comparing the caption file text embeddings 102 and the ASR text embeddings 104 to synchronize multi-language subtitles, it should be noted that the system and method may synchronize multi-language subtitles using other suitable techniques to leverage the particularly credible translations in a caption file with the particularly credible syncing (e.g., timing) in an ASR text file. Moreover, although the following descriptions of generating the matrix 100 is described as being performed by the synchronization system 12, it should be noted that any suitable computing device (e.g., computing device 18) or combination of computing devices may be used.

Referring now to FIG. 3, the synchronization system 12 may retrieve a caption file from the caption database 14 and an ASR text file from the ASR database 16 corresponding to the same original language content and foreign language (e.g., files containing English translations of a German film). In an aspect, the synchronization system 12 may retrieve a caption file and an ASR text file corresponding to the same original language content, but corresponding to different languages (e.g., a caption file containing English translations of a German film and an ASR text file containing the original German and/or translations of the German film in another foreign language). The synchronization system 12 may employ natural language processing techniques to extract utterances (e.g., sentences, clauses, phrases, words) from the caption file and the ASR text file. For example, the synchronization system 12 may use natural language processing techniques to segment the caption file and the ASR text file into sentence-by-sentence utterances. In an aspect, utterances having different segmentation windows may also be utilized (e.g., 3-, 4-, 5-, . . . , z-word segmentation window). In certain aspects, the synchronization system 12 may preprocess the caption file and the ASR text file into a compatible format for language processing (e.g., remove capitalization and punctuation, write out all numbers/symbols, etc.) prior to extracting the utterances. Each utterance may contain metadata from the respective caption file or ASR text file. For example, each utterance may include timestamps associating the text with a specific time interval of the audio file of the respective original language content, as well as tags indicating the title of the audiovisual content, the original language of the content, the respective foreign language the content is translated into, and the like.

When the caption file and the ASR text file are segmented into respective utterances, the synchronization system 12 may employ a suitable massive language text embedding model to convert the caption file utterances and the ASR text file utterances into respective caption file text embeddings 102 and ASR text embeddings 104. Text embeddings are multidimensional vectors that act as numerical representations of text, where each dimension is used to capture features (e.g., semantics) of the text. Accordingly, text embeddings may be used to mathematically compare the similarities and differences between two or more text strings. Certain massive language text embedding models may be used to mathematically compare the similarities between two or more text strings in two or more different languages (e.g., may capture the semantics of text across different languages). Accordingly, the synchronization system 12 may compare a caption file and an ASR text file corresponding to the same original language content in different languages (e.g., a caption file containing English translations of a German film and an ASR text file containing the original German and/or translations of the German film in another foreign language). The massive language text embedding model may be selected based on the model size, memory usage, embedding dimensions, language it is trained on, and the like. Any suitable massive language text embedding model may be selected, such as from the massive language text embedding benchmark (MTEB), as long as the same model is used to extract the caption file text embeddings 102 and the ASR text embeddings 104 to allow for compatible mathematical comparisons.

The synchronization system 12 may then compare the caption file text embeddings 102 and the ASR text embeddings 104. For example, the synchronization system 12 may calculate cosine distance values to compare each of the caption file text embeddings 102 against each of the ASR text embeddings 104. The synchronization system 12 may generate the matrix 100 by outputting each cosine distance value to a time-ordered matrix. In the illustrated example, the rows or y-axis of the matrix 100 represent the caption file and the columns or x-axis of the matrix 100 represent the ASR text. For example, the first row of the matrix 100 is populated with each of the cosine distance values between a first caption file text embedding 102 and each ASR text embedding 104. Likewise, the first column of the matrix 100 is populated with each of the cosine distance values between a first ASR text embedding 104 and each caption file text embedding 102. The synchronization system 12 may tag each row and column of the matrix 100 with its respective time interval 106 and utterance 108 (e.g., text used to generate the embedding). While the illustrated example shows each row and column labeled with its respective start time 110 and end time 112, the synchronization system 12 may tag each row and column with either the start time 110 or end time 112 rather than the time interval 106 (e.g., in instances where limited time information is available for caption files and/or when only some of the time information is used to enable less computing time, etc.).

Cosine distance values range from zero to two, where a value of zero indicates identical vectors, a value of one indicates orthogonal vectors (i.e., no relation), and a value of two indicates opposite vectors (i.e., absolutely different). Accordingly, the synchronization system 12 may sync the caption file with the original language audio by determining the minimum (shortest) distance pathway to traverse the matrix. For example, the synchronization system 12 may start in the upper left-hand corner of the matrix 100 (e.g., the entry associated with the first row and the first column) and may select from among three different options of a pathway: one moving right to the entry associated with the first row and the second column as indicated by arrow 114, another down to the entry associated with the second row and the first column as indicated by arrow 116, and lastly diagonally right to the entry associated with the second row and the second column as indicated by arrow 118. The synchronization system 12 may then generate three more options of a pathway from these three pathways by moving from the respective entry to the entry to the right, the entry underneath, and the entry diagonal-right, and may continue to generate more pathways until reaching the bottom right-hand corner (e.g., entry associated with the eighth row, seventh column in the example matrix 100). Certain pathways may reach the right-hand side of the matrix (e.g., last column) before reaching the bottom right-hand corner, in which case the synchronization system 12 may force the pathway down until it reaches the bottom right hand corner without generating further iterations of the pathway moving right or diagonal-right.

Accordingly, the synchronization system 12 may employ this iterative approach to generate a multitude of pathways traversing the matrix 100, each starting in the upper left-hand corner and ultimately ending in the bottom right-hand corner. The synchronization system 12 may then sum the cosine distance values in each entry along a pathway to determine the distance of each pathway. The minimum (e.g., shortest) distance pathway may then be used to sync the caption file subtitles with the original language content (e.g., audio), via the ASR text file timestamps. For example, a minimum distance pathway moving diagonally from the upper left-hand corner of the matrix 100 directly to the bottom right-hand corner of the matrix 100 indicates a strong correlation between the caption file and the ASR text file, in which case the synchronization system 12 may determine that the caption file subtitles are adequately synced with the original language content. Conversely, the synchronization system 12 may generate suggested changes in the timings of caption file subtitles in cases where the minimum distance pathway deviates from a direct diagonal path (e.g., in cases where the text of the caption file does not match with the text of the ASR text file at certain time intervals).

In certain aspects, the synchronization system 12 may not generate a multitude of pathways traversing the matrix 100. Rather, the synchronization system 12 may compare each caption file text embedding 102 against a respective subset of ASR text embeddings 104 to minimize computing power usage. For example, the synchronization system 12 may only compare caption file text embeddings 102 against ASR text file embeddings 104 corresponding to the same scene, or time interval within the respective audiovisual content. Accordingly, the synchronization system 12 may perform a first pass comparison between the caption file subtitles and the ASR text file detected dialog to verify if the caption file subtitles are currently synchronized with the audio of the audiovisual content. That is, the synchronization system 12 may generate a single pathway moving diagonally from the upper left-hand corner of the matrix 100 directly to the bottom right-hand corner of the matrix 100 to only compare caption file text embeddings 102 against ASR text embeddings 104 with substantially the same time interval 106 (e.g., within a threshold time difference of 2 seconds, 3 seconds, etc.). When the synchronization system 12 verifies that caption file subtitles are substantially synchronized with the audio using the first pass comparison, the synchronization system 12 may forgo any further comparisons and notify a user (e.g., send a notification to the display 40, send a notification to the computing device 18) that the caption file subtitles are accurately timed with the audiovisual content. Conversely, when the synchronization system 12 determines that the caption file subtitles are not substantially synchronized with the audio using the first pass comparison (e.g., have a low level of similarity with the ASR text file dialog with substantially the same time intervals 106), the synchronization system 12 may broaden the range of comparison (e.g., generate additional pathways comparing caption file text embeddings 102 against a wider range of ASR text embeddings 104) to generate suggested changes to the time intervals 106 of the caption file subtitles to synchronize the caption file subtitles with the audiovisual content.

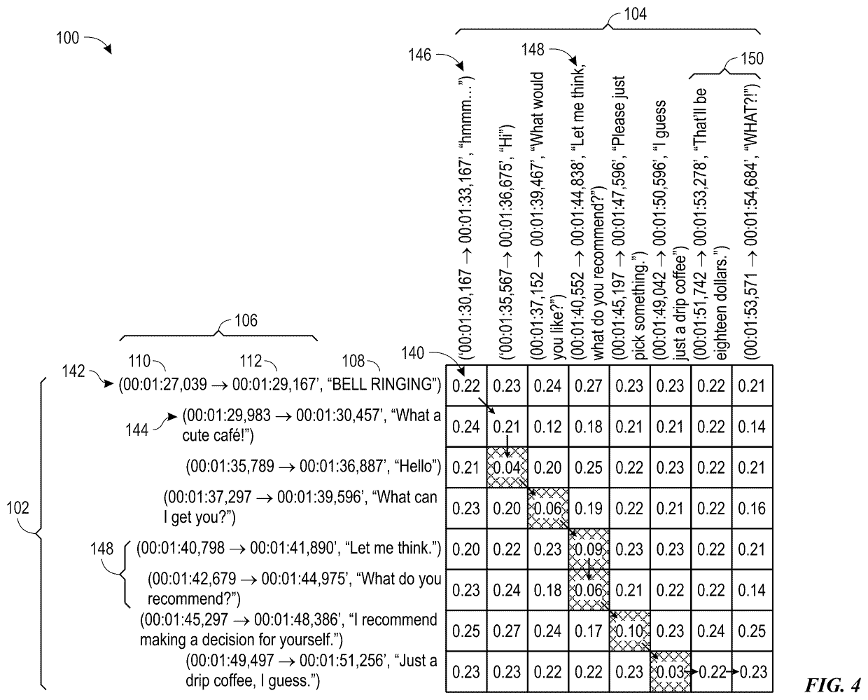

The synchronization system 12 may use threshold values to determine suggested changes. For example, the synchronization system 12 may reference a maximum allowable time difference between the caption file subtitles and the ASR text file timestamps (e.g., 2 seconds, 3 seconds, etc.) to determine if the caption file subtitle timing should be adjusted (e.g., replace a specific caption file utterance's associated time interval with a specific ASR text file utterance's associated time interval). Likewise, the synchronization system 12 may reference a maximum allowable cosine distance value (e.g., 0.1, 0.15, etc.) to determine if an utterance 108 should be pruned from the matrix 100 (e.g., remove a column from the matrix 100 when the ASR text file includes an utterance that is not included in the caption file). Examples of pruning the matrix 100 will be discussed in greater detail below with regards to FIG. 4.

FIG. 4 illustrates an optimal pathway 140 through the matrix 100 of FIG. 3, generated using the iterative approach described above. Accordingly, the illustrated optimal pathway 140 corresponds to the minimum distance pathway of the matrix 100 determined based on the cosine distance values of the caption file text embeddings 102 and the ASR text embeddings 104.

Referring now to FIG. 4, the synchronization system 12 may generate suggested changes to the timings of the of the caption file subtitles based on features of the optimal pathway 140, such as deviations from a direct diagonal path from the upper left-hand corner to the bottom right-hand corner of the matrix 100. These deviations may be associated with less credible caption file timestamps (e.g., dissimilar time intervals 106), less credible ASR text file dialog (e.g., dissimilar utterances 108), and the like. Additionally, the synchronization system 12 may use threshold values (e.g., maximum allowable time interval difference, maximum allowable cosine distance value) to determine suggested actions to resolve the deviations, thereby syncing the caption file subtitles.

For example, in the illustrated example of FIG. 4, the caption file embeddings 102 include a forced narrative subtitle 142. Forced narrative subtitles contain text that is not associated with spoken dialog, such as location indications (e.g., “interior of coffee shop”), descriptions of atmosphere (e.g., “spooky echoing”), and the like, that may not be captured by the ASR tool in the ASR text files. Therefore, the forced narrative subtitle 142 corresponding to the utterance 108 “BELL RINGING” may not have an equivalent ASR text utterance 108. The synchronization system 12 may detect the forced narrative subtitle 142 by applying a threshold value, such as comparing its respective cosine distance values to a maximum allowable cosine distance value (e.g., 0.2) and determining that the cosine distance values consistently exceed the threshold. Accordingly, the synchronization system 12 may flag the time interval 106 associated with the forced narrative subtitle 142 for a human operator to review.

Alternatively, or additionally, the synchronization system 12 may recommend no changes when there are no other deviations between the caption file subtitles and the ASR text, or may generate a suggested time interval 106 for the forced narrative subtitle 142 when there are deviations. For example, the synchronization system 12 may recommend a suggested start time 110 for the forced narrative subtitle 142 based on the last substantially matching timing between the caption file and the ASR text file (e.g., an entry to the left of the respective entry), and/or may recommend a suggested end time 112 based on the next substantially matching timing between the caption file and the ASR text file (e.g., an entry to the right of the respective entry). That is, the synchronization system 12 may suggest a start time 110 by applying a predetermined offset time (e.g., +2 seconds, +3 seconds, etc.) to the end time 112 of the last ASR text embedding 104 with a high similarity (e.g., cosine distance value below a threshold value) with the corresponding caption file text embedding 102, and/or may suggest an end time 112 by applying a predetermined offset (e.g., −2 seconds, −3 seconds) to the start time 110 of the next ASR text file embedding 104 with a high similarity with the corresponding caption file text embedding 102.

Further, the caption file text embeddings 102 may contain a subtitle that was not registered by the ASR tool during generation of the ASR text file. For example, in the illustrated example, the caption file text embeddings 102 include the missed subtitle 144 corresponding to the utterance 108 “What a cute café!”. As described above with regards to the forced narrative subtitle 142, the synchronization system 12 may detect the missing subtitle 142 by referencing a threshold value (e.g., maximum allowable cosine difference value), flag the time interval 106 associated with the missed subtitle 144 for review, and/or may generate a suggested time interval 106 for the missed subtitle 144.

Likewise, the ASR text embeddings 104 may contain non-speech human sounds, such as grunts, screams, and other vocal sounds that are not included in the caption file text embeddings 102. For example, in the illustrated example, the ASR text embeddings 104 contain a non-speech sound 146 corresponding to the utterance 108 “hmmm . . . ”. As described above with regards to the forced narrative subtitle 142 and the missing subtitle 144, the synchronization system 12 may detect the missing subtitle 142 by referencing a threshold value (e.g., maximum allowable cosine difference value) and flag the time interval 106 associated with the missed subtitle 144 for review. However, since the ASR text file has less credible text with credible (e.g., substantially accurate) timings, the synchronization system 12 may recommend pruning (e.g., removing) the column associated with the non-speech sound 146 or may automatically prune the column, rather than generate suggestions related to the timing of the non-speech sound 146.

The optimal pathway 140 may also deviate from a direct diagonal path from the upper left-hand corner to the bottom right-hand corner of the matrix 100 when one or more caption file utterances and ASR text file utterances are segmented differently. For example, in the illustrated example, the caption file segmented a piece of dialog 148 into two different utterances 108 (“Let me think.” and “What do you recommend?”) that the ASR text file segmented into one utterance 108 (“Let me think, what do you recommend?”). The synchronization system 12 may detect this by determining that two or more consecutive rows (i.e., caption file text embeddings) closely match the same column (i.e., ASR text embedding). That is, the synchronization system 12 may compare the respective cosine distance values to a threshold (e.g., cosine distance value less than or equal to 0.1) to determine that two or more caption file embeddings 102 substantially match one ASR text embedding 104, or vice versa.

In response to determining that multiple caption file text embeddings 102 correspond to a single ASR text embedding 104, or vice versa, the synchronization system 12 may recommend no change in instances where the neighboring caption file text embeddings 102 substantially agree with the timings of the corresponding ASR text embeddings 104 (e.g., having time intervals 106 within a threshold time difference). Alternatively, the synchronization system 12 may generate recommended time interval(s) for the caption file text embeddings 102 in instances where the caption file subtitles appear to be out of sync with the original language content (e.g., having time intervals 106 consistently outside a threshold time difference compared to ASR text file time intervals 106). For example, the synchronization system 12 may suggest assigning the start time 110 of the ASR text embedding 104 corresponding to the dialog 148 to the first caption file text embedding 102 corresponding to the dialog 148, assigning the end time 112 of the ASR text embedding 104 corresponding to the dialog 148 to the last (e.g., second) caption file text embedding 102 corresponding to the dialog 148, and assigning the remaining end time 112 and start time 110 by dividing the ASR text embedding 104 time interval in half (e.g., by the number of caption file text embeddings associated with the same dialog 148) to determine a suggested time interval length for each caption file text embedding 102 corresponding to the dialog 148.

In the illustrated example, the matrix 100 includes two ASR text embeddings 104 associated with dialog 150 that is not captured in the caption file text embeddings 102. This may occur when there is a timing offset between the caption file subtitles and the ASR text file causing the caption file subtitles to be cut off before the end of the respective scene, when there are forced narrative subtitles 142 in the caption file, when there are missed subtitles 144 not registered by the ASR tool, when there are non-speech sounds 146 in the ASR text file, and the like. Regardless, the synchronization system 12 may flag the two ASR text embeddings associated with the dialog 150 for an operator to review, based on the corresponding cosine distance values consistently exceeding a maximum cosine distance value threshold (e.g., 0.2).

The synchronization system 12 may generate multiple matrices to determine the synchronicity between the caption file subtitles and the original language content (e.g., audio) and/or sync the caption file subtitles with the original language content. For example, the synchronization system 12 may generate a matrix for each scene in the original language content. Additionally, or alternatively, the synchronization system 12 may generate a single matrix containing dialog from each scene in the original language content. In instances where the synchronization system 12 generates multiple matrices, the synchronization system 12 may allow a human operator to redefine the dimensions of each matrix (e.g., add or remove one or more rows or columns) to ensure that caption file subtitles are compared against ASR text for the same respective scene.

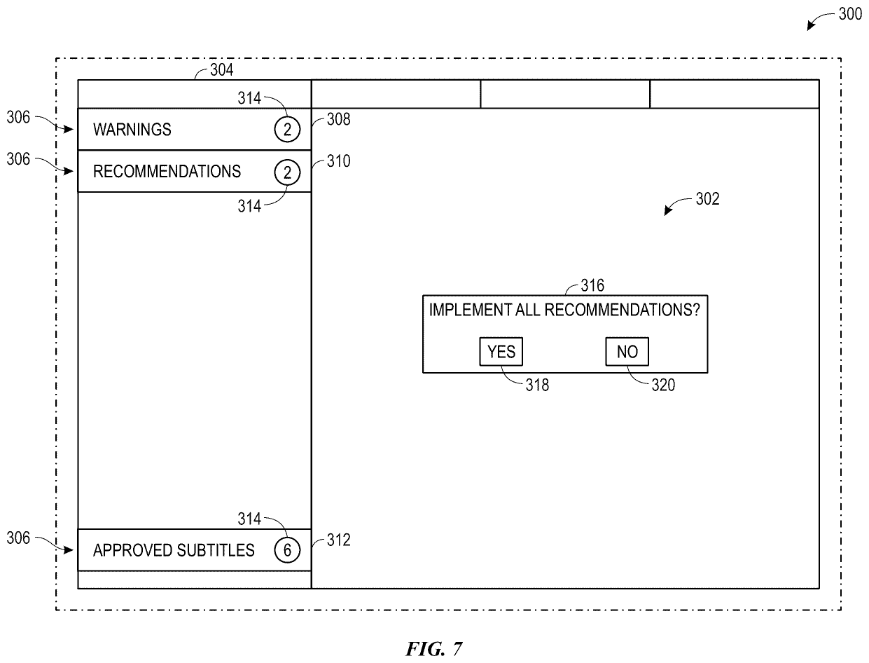

The synchronization system 12 may generate visualizations of the matrix or matrices to allow users to more quickly interpret the synchronization analysis. For example, the visualizations may include a heatmap visualization with darker color gradients used for values indicating a higher level of similarity (e.g. smaller cosine distance values), an optimal pathway visualization with arrows or lines tracing the optimal pathway (e.g., minimum distance pathway) similar to FIG. 4, and the like. These visualizations may be displayed via a graphical user interface (GUI) directly through the synchronization system 12 (e.g., via display 40) and/or may be sent to the computing device 18 or any other suitable device. Additionally, the synchronization system 12 may generate reports indicating the level of similarity (e.g., synchronicity) between the caption file and the ASR text file with selectable options to allow a user to approve caption file subtitles, review specific flagged time intervals in the subtitled audiovisual content for any inconsistencies, and/or implement suggested changes to the timings of caption file subtitles with respect to the original language content. These reports may be displayed via a graphical user interface (GUI) directly through the synchronization system 12 (e.g., via display 40) and/or may be sent to the computing device 18 or any other suitable device. These visualizations and reports will be discussed in greater detail below with regards to FIG. 7.

While the illustrated examples of FIG. 3 and FIG. 4 utilize cosine distance values and determining a minimum distance pathway to sync the caption file with the original language content via the ASR text file, it should be noted that the synchronization system 12, or any other suitable computing system (e.g., computing device 18), may employ other suitable techniques to leverage the particularly credible translations in a caption file with the particularly credibly syncing (e.g., timing) in an ASR text file. For example, the synchronization system 12 may calculate cosine similarity values to compare each caption file embedding 102 against each ASR text embedding 104, and may determine a maximum (e.g., longest) distance pathway traversing a time-ordered matrix of the cosine similarity values to sync the caption file with the original language content via the ASR text file.

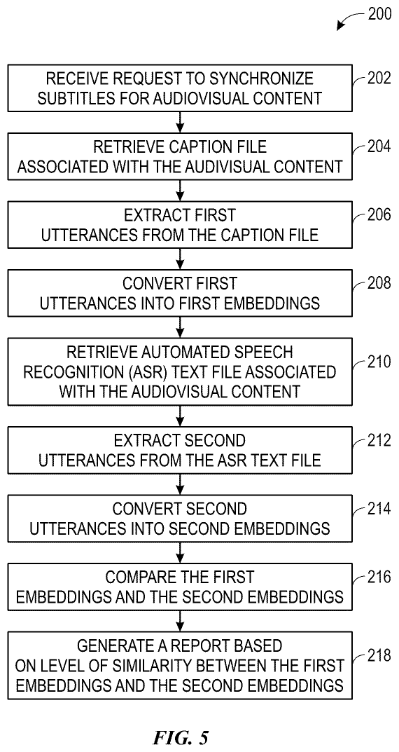

FIG. 5 illustrates a block diagram of a method 200 for multiple language subtitle synchronization. Although the following description of the method 200 is described in a particular order, it should be noted that the method 200 may be performed in any suitable order. Moreover, although the following description of method 200 is described as being performed by the synchronization system 12, it should be noted that the method 200 may be performed by any suitable computing device (e.g., computing device), or combination of computing devices.

Referring now to FIG. 5, at block 202, the synchronization system 12 may receive a request to synchronize subtitles for audiovisual content. The synchronization system 12 may receive the request directly. For example, the display 40 may receive user inputs indicative of a selection of audiovisual content (e.g., specific movie, television show episode, etc.), a desired subtitle language, and the like. Alternatively, as discussed above with regards to FIG. 1, the synchronization system 12 may receive a request to synchronize and/or confirm the synchronization of subtitles for a specific movie, television show episode, and the like, from the computing device 18.

At block 204, in response to the request, the synchronization system 12 may retrieve a caption file associated with the selected audiovisual content from the caption database 14. For example, the synchronization system 12 may query the caption database 14 with specific search terms and filters based on features of the request to synchronize subtitles for audiovisual content (e.g., filtering by audiovisual content title, original language, desired foreign language translation, etc.) to retrieve the relevant caption file. As discussed above, the caption file may be a text file with credible (e.g., substantially accurate) text of dialog from the selected audiovisual content derived from transcripts, screenplays, commentaries, and the like, and minimal or less credible information (e.g., timestamps in the metadata) related to timing the text with the audio of the selected audiovisual content.

At block 206, the synchronization system 12 may employ natural language processing techniques to extract a first set of utterances (e.g., sentences, clauses, phrases, words) from the caption file. For example, the synchronization system 12 may utilize natural language processing techniques to segment the caption file into sentence-by-sentence utterances. In certain aspects, the synchronization system 12 may preprocess the caption file into a compatible format for language processing prior to extracting the first set of utterances. For example, the synchronization system 12 may run a software application or program on the caption file to remove any capitalization and punctuation, convert any symbols into text descriptions (e.g., write out all numbers), and the like, before employing the natural language processing techniques. Each utterance of the first set of utterances may contain metadata from the caption file. That is, each utterance may include a timestamp associating the text with a specific time interval of the audio file of the respective audiovisual content, as well as tags indicating the title of the audiovisual content, the original language of the content, the language of the caption file subtitles which may or may not be the same as the original language, and the like.

At block 208, the synchronization system 12 may then convert the first set of utterances into a first set of text embeddings (i.e., caption file text embeddings 102). As discussed above, text embeddings are multidimensional vectors that act as numerical representations of text, where each dimension is used to capture semantics of the respective text. Accordingly, the synchronization system 12 may utilize the first set of text embeddings to mathematically compare the semantics of the first set of utterances against text embeddings of other text strings. The synchronization system 12 may employ any suitable massive language text embedding model to convert the first set of utterances into the first set of text embeddings. For example, the synchronization system 12 may select a massive language text embedding model based on the model size, memory usage, embedding dimensions, language the model is trained on, and the like. Any suitable massive language text embedding model may be selected, such as from the massive language text embedding benchmark (MTEB), as long as the same model is used to convert the utterances of the text string the caption file is being compared against to allow for mathematically compatible text embeddings.

At blocks 210-214, the synchronization system 12 may perform substantially the same process as blocks 204-208 with an automated speech recognition (ASR) text file. That is, at block 210, the synchronization system 12 may retrieve an ASR text file from the automated speech recognition (ASR) database 16 based on properties of the request to synchronize subtitles for audiovisual content. Further, at block 212, the synchronization system 12 may employ natural language processing techniques to extract a second set of utterances (e.g., sentences, clauses, phrases, words) from the ASR text file. Moreover, at block 214, the synchronization system 12 may employ the selected massive language text embedding model to convert the second set of utterances into a second set of embeddings (i.e., ASR text embeddings 104). The synchronization system 12 may segment the ASR text file into the same type of utterance (e.g., sentence-by-sentence, clause-by-clause, etc.) as the caption file, and may utilize the same selected massive language text embedding model to convert the second set of utterances into the second set of embeddings to enable accurate mathematical comparisons between the first and second set of embeddings. As discussed above, the ASR text file may be generated using an Automated Speech Recognition (ASR) tool on an audio file of the selected audiovisual content, and thus, may have credible (e.g., substantially accurate) information related to timing text with the audio of the selected audiovisual content (e.g., timestamps in the metadata), and less credible text of the dialog of the selected audiovisual content.

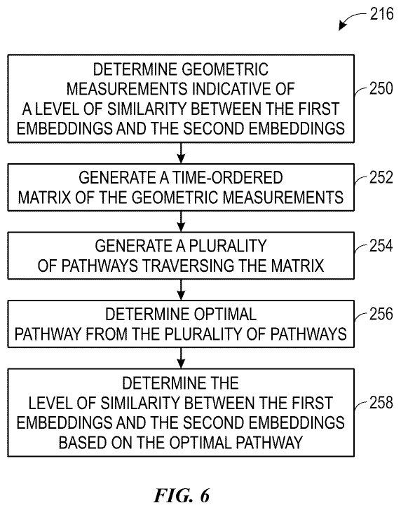

At block 216, the synchronization system 12 may compare the first set of embeddings (i.e., caption file text embeddings 102) against the second set of embeddings (i.e., ASR text embeddings 104). In certain aspects, the synchronization system 12 may compare each embedding of the first set of embeddings against each embedding of the second set of embeddings, thereby comparing each utterance in the caption file against each utterance in the ASR text file. Alternatively, the synchronization system 12 may compare each embedding of the first set of embeddings against a respective subset of embeddings in the second set of embeddings to minimize computing power usage. For example, the synchronization system 12 may only compare embeddings from the first set of embeddings against embeddings from the second set of embeddings corresponding to the same scene, or time interval within the respective audiovisual content. Accordingly, the synchronization system 12 may perform a first pass comparison between the caption file subtitles and the ASR text file detected dialog to verify if the caption file subtitles are currently synchronized with the audio of the audiovisual content. That is, the synchronization system 12 may only compare caption file text embeddings 102 against ASR text embeddings 104 with substantially the same time interval 106 (e.g., within a threshold time difference of 2 seconds, 3 seconds, etc.). When the synchronization system 12 verifies that caption file subtitles are substantially synchronized with the audio using the first pass comparison (e.g., have a high level of similarity with the ASR text file dialog with substantially the same time intervals 106), the synchronization system 12 may forgo any further comparisons and notify a user (e.g., send a notification to the display 40, send a notification to the computing device 18) that the caption file subtitles are accurately timed with the audiovisual content. Conversely, when the synchronization system 12 determines that the caption file subtitles are not substantially synchronized with the audio using the first pass comparison (e.g., have a low level of similarity with the ASR text file dialog with substantially the same time intervals 106), the synchronization system 12 may broaden the range of comparison (e.g., compare caption file text embeddings 102 against a wider range of ASR text embeddings 104) to generate suggested changes to the time intervals 106 of the caption file subtitles to synchronize the caption file subtitles with the audiovisual content. Additional details with regard to comparing the first embeddings (i.e., caption file text embeddings 102) and the second embeddings (i.e., ASR text embeddings 104) will be described with reference to FIG. 6.

At block 218, the synchronization system 12 may generate a report based on the level of similarity between the first embeddings (i.e., caption file text embeddings 102) and the second embeddings (i.e., ASR text embeddings 104). For example, the synchronization system 12 may generate a report indicating the level of similarity (e.g., synchronicity) between the first embeddings (i.e., caption file) and the second embeddings (i.e., ASR text file) with selectable options to allow a user to approve caption file subtitles, review specific flagged time intervals in the subtitled audiovisual content for any inconsistencies, and/or implement suggested changes to the timings of caption file subtitles with respect to the audiovisual content. Additionally, the report may contain visualizations of the method used to compare the first embeddings against the second embeddings to allow the user to more quickly interpret the synchronization analysis. The report may be displayed via a graphical user interface (GUI) directly through the synchronization system 12 (e.g., via display 40) and/or may be sent to the computing device 18 or any other suitable device. These reports and visualizations will be discussed in greater detail below with regards to FIG. 7.

Referring back to block 216 of FIG. 5, FIG. 6 illustrates a flow chart of an example method for comparing the first embeddings (i.e., caption file text embeddings 102) and the second embeddings (i.e., ASR text embeddings 104). At block 250, the synchronization system 12 may determine geometric measurements indicative of the level of similarity between the first embeddings and the second embeddings. For example, the synchronization system 12 may calculate cosine distance values, cosine similarity values, and the like, to compare the first embeddings against the second embeddings. As discussed above, the synchronization system 12 may compare each embedding of the first embeddings against each embedding of the second embeddings, or may compare each embedding of the first embeddings against a respective subset of the second embeddings corresponding to a respective scene or time interval 106.

At block 252, the synchronization system 12 may generate a time-ordered matrix of the geometric measurements, such as the matrix 100 of FIGS. 3 and 4 populated with cosine distance values. The rows or y-axis of the time-ordered matrix may represent the caption file, and thus contain geometric measurements associated with respective embeddings from the first embeddings. The columns or x-axis of the time-ordered matrix may represent the ASR text file, and thus contain geometric measurements associated with respective embeddings from the second embeddings. For example, the first row of the time-ordered matrix may be populated with each of the cosine distance values between a first caption file text embedding 102 with the earliest time interval 106 of the first embeddings and each ASR text embedding 104 of the second embeddings. Likewise, the first column in the time-ordered matrix may be populated with each of the cosine distance values between a first ASR text file embedding 104 with the earliest time interval 106 of the second embeddings and each caption file text embedding 102 of the first embeddings.

At block 254, the synchronization system 12 may generate a plurality of pathways traversing the time-ordered matrix, each starting in the upper left-hand corner and ultimately ending in the bottom right-hand corner. For example, the synchronization system 12 may start in the upper left-hand corner of the time-ordered matrix (e.g., the entry associated with the first row and the first column) and may employ three different iterations of a pathway: one moving right to the entry associated with the first row and the second column, another down to the entry associated with the second row and the first column, and lastly diagonally right to the entry associated with the second row and the second column. The synchronization system 12 may then generate three more iterations of a pathway from these three pathways by moving from the respective entry to the entry to the right, the entry underneath, and the entry diagonal-right, and so on, and may continue to generate more pathways until reaching the bottom right-hand corner. Certain pathways may reach the right-hand side of the matrix (e.g., last column) before reaching the bottom right-hand corner, in which case the synchronization system 12 may force the pathway down until it reaches the bottom right hand corner without generating further iterations of the pathway moving right or diagonal-right.

At block 256, the synchronization system 12 may determine an optimal pathway from the plurality of pathways. The synchronization system 12 may sum the geometric measurements (or numerical values) in each entry along a pathway to “score” the pathway, and then determine the optimal pathway based on the scores. For example, when the synchronization system 12 uses cosine distance values as the geometric measurements, the synchronization system 12 may determine the optimal pathway by determining which pathway of the plurality of pathways has the lowest score (i.e., the minimum summation of cosine distance values), as lower cosine distance values are associated with a higher level of similarity between vectors. Conversely, when the synchronization system 12 uses cosine similarity values as the geometric measurements, the synchronization system 12 may determine the optimal pathway by determining which pathway of the plurality of pathways has the highest score (i.e., the maximum summation of cosine similarity values), as higher cosine similarity values are associated with a higher level of similarity between vectors.

At block 258, the synchronization system 12 may determine the level of similarity between the first embeddings and the second embeddings based on features of the optimal pathway. An optimal pathway moving diagonally from the upper left-hand corner directly to the bottom right-hand corner of the time-ordered matrix indicates the strongest possible correlation between the first embeddings (i.e., the caption file) and the second embeddings (i.e., the ASR text file), as it indicated that the embeddings with the most similar time intervals 106 have the most similar utterances 108. Accordingly, the synchronization system 12 may determine that the first embeddings and the second embeddings have a high level of similarity when the optimal path does not deviate or only slightly deviates from this direct diagonal path. Conversely, the synchronization system 12 may determine that the first embeddings and the second embeddings have a low level of similarity when the optimal path deviates from this direct diagonal path.

As discussed above, the synchronization system 12 may generate a report based on the level of similarity between the first embeddings and the second embeddings. The report may contain selectable options to approve the caption file subtitles (e.g., send the caption file subtitles to a next phase in the production process without changing the timing), implement suggested changes, and the like. Additionally, the report may contain visualizations of the method used to compare the caption file and the ASR text file, such as visualizations of a time-ordered matrix (e.g., matrix 100). The report may be displayed via a graphical user interface (GUI). FIG. 7 is a block diagram of a GUI of the system of FIG. 1 that may display reports and facilitate user interaction with the system of FIG. 1.

In the illustrated example, the GUI 300 includes a display window 302. The display window 302 may display visualizations and/or summaries of the synchronization analysis performed by the synchronization system 12. For example, the display window 302 may display a heatmap visualization of a time-ordered matrix used to compare a caption file and an ASR text file with darker color gradients used for geometric measurement values indicating a higher level of similarity, an optimal pathway visualization with arrows or lines tracing an optimal pathway through the time-ordered matrix, and the like. Additionally, or alternatively, the display window 302 may display summaries describing the general level of similarity between the caption file and the ASR text file (e.g., high, low, inconclusive, etc.), as well as notable time intervals within the audiovisual content (e.g., time intervals with higher than average similarity indicating closer synchronization, time intervals with lower than average similarity indicating a lack of synchronization, etc.).

Additionally, the GUI 300 may include a menu listing 304 having drop-down options 306, such as a warnings menu 308, a recommendations menu 310, and an approved subtitles menu 312. Each of the drop-down options 306 may include an indicator 314 that may indicate the presence or number of outstanding actions a user can take. For example, the indicator 314 of the warnings menu 308 may include the number of flagged time intervals of the subtitled audiovisual content for the user to review. The user may navigate to the warnings menu 308 to select a time interval to review, and may review the subtitled audiovisual content within the display window 302. The recommendations menu 310 may enable the user to review the one or more suggested changes generated by the synchronization system 12, such as replacing a time interval of a caption file utterance with a time interval of an ASR text file utterance. The approved subtitle menu 312 may enable the user to approve caption file subtitles that the synchronization system 12 determined are sufficiently synced with audio from the audiovisual content, and/or may enable the user to review the caption file subtitles that were automatically approved by the synchronization system 12.

The GUI 300 may include a pop-up window notification 316 requesting approval to implement the recommendations (e.g., suggested timing changes). The user may select a YES option 318 to approve the recommendations or a NO option 320. The synchronization system 12 may carry out the suggested changes (e.g., alter the timestamps of the caption file subtitles) in response to receiving an indication that the YES option 318 is selected, and may generate one or more alternative recommendations in response to receiving an indication that the NO option 320 is selected. While not illustrated, the GUI 300 may include substantially similar pop-up window notifications requesting user input to approve caption file subtitles, display warnings, and the like.

The presently disclosed systems and methods utilize natural language processing techniques and language models to leverage particularly credible translations of original language audiovisual content in caption files with particularly credible timing in automated speech recognition (ASR) text files to synchronize subtitles for audiovisual content. Accordingly, the presently disclosed techniques may translate original language content into multi-language subtitles and sync the multi-language subtitles with the original language audiovisual content in a more time-efficient, labor-efficient, and cost-efficient manner than traditional methods.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
processing circuitry; and
a memory accessible by the processing circuitry, the memory storing instructions that, when executed by the processing circuitry, cause the processing circuitry to perform operations comprising:
retrieving a first file associated with audiovisual content, wherein the first file comprises a first set of captions associated with the audiovisual content, and wherein each caption of the first set of captions comprises a time interval defining when each caption is to be provided during display of the audiovisual content;
retrieving a second file, wherein the second file comprises a second set of captions associated with the audiovisual content, and wherein each caption of the second set of captions comprises a time interval defining when each caption was observed during the audiovisual content;
converting the first file into a first set of embeddings and the second file into a second set of embeddings, wherein the first set of embeddings and the second set of embeddings comprise multidimensional vector representations of text;
comparing the first set of embeddings and the second set of embeddings to determine a level of similarity between the first set of embeddings and the second set of embeddings to determine a level of synchronicity between the first file and the audiovisual content; and
generating a report based on the level of similarity between the first set of embeddings and the second set of embeddings.

2. The system of claim 1, wherein the operations further comprise receiving a request to synchronize subtitle text with the audiovisual content prior to retrieving the first file and the second file, wherein the request comprises an identification of the audiovisual content and a desired subtitle language, and wherein the identification of the audiovisual content and the desired subtitle language are utilized to uniquely identify the first file and the second file.

3. The system of claim 2, wherein a translator generated the first set of captions by translating dialog from the audiovisual content into the desired language.

4. The system of claim 2, wherein a machine translation service generated the second set of captions by translating an automated speech recognition text file associated with the audiovisual content into the desired language.

5. The system of claim 1, wherein the operations further comprise:
extracting, via natural language processing techniques, a first set of utterances from the first file and a second set of utterances from the second file, wherein each utterance from the first set of utterances is associated with a sentence from the first set of captions, and each utterance from the second set of utterances is associated with a sentence from the second set of captions; and
converting, via a massive language text embedding model, the first set of utterances into the first set of embeddings and the second set of utterances into the second set of embeddings.

6. The system of claim 1, wherein comparing the first set of embeddings and the second set of embeddings comprises:
determining geometric measurement values indicative of the level of similarity between the first set of embeddings and the second set of embeddings;
generating a time-ordered matrix comprising the geometric measurements, wherein each row of the matrix is associated with a respective embedding from the first set of embeddings and ordered based off of a respective time interval associated with the respective embedding from the first set of embeddings, and each column of the matrix is associated with a respective embedding from the second set of embeddings and ordered based off of a respective time interval associated with the respective embedding from the second set of embeddings;
generating a plurality of pathways traversing the matrix, wherein each pathway of the plurality of pathways begins in an upper left-hand corner of the matrix and terminates in a bottom right-hand corner of the matrix;
determining a score for each pathway of the plurality of pathways based on a summation of geometric measurement values associated with each entry of the matrix comprising the respective pathway;
determining an optimal pathway of the plurality of pathways based on the score for each pathway of the plurality of pathways; and
determining the level of similarity between the first set of embeddings and the second set of embeddings based on the optimal pathway, wherein a greater level of similarity between the first set of embeddings and the second set of embeddings is associated with a greater level of synchronicity between the first file and the audiovisual content.

7. The system of claim 6, wherein the geometric measurement values comprise cosine distance values and the optimal pathway is determined based on a minimum score.

8. The system of claim 6, wherein one or more columns of the matrix are pruned based on the respective geometric measurement values exceeding a threshold value associated with an acceptable level of similarity.

9. The system of claim 1, wherein the report is displayed via a graphical user interface (GUI), and wherein the report comprises one or more selectable options indicative of a command to approve the first set of captions as subtitle text, implement a suggested change to a time interval of one or more captions of the first set of captions, review a time interval of the audiovisual content with one or more captions of the first set of captions displayed, or any combination thereof.

10. The system of claim 9, wherein the suggested change comprises replacing the time interval of the one or more captions of the first set of captions with a time interval of one or more captions of the second set of captions.

11. A non-transitory computer-readable medium comprising computer readable medium comprising instructions that, when executed by processing circuitry, causes the processing circuitry to perform operations comprising:
retrieving a first file associated with audiovisual content from a first database, wherein the first file comprises a first set of captions associated with the audiovisual content, wherein each caption of the first set of captions comprises a time interval defining when each caption is provided during display of the audiovisual content;
retrieving a second file from a second database, wherein the second file comprises a second set of captions associated with the audiovisual content, wherein each caption of the second set of captions comprises a time interval defining when each caption is provided during display of the audiovisual content;
converting the first file into a first set of embeddings and the second file into a second set of embeddings, wherein the first set of embeddings and the second set of embeddings comprise multidimensional vector representations of text;
comparing the first set of embeddings and the second set of embeddings to determine a level of similarity between the first set of embeddings and the second set of embeddings to determine a level of synchronicity between the first file and the audiovisual content; and
generating a report based on the level of similarity between the first set of embeddings and the second set of embeddings.

12. The non-transitory computer-readable medium of claim 11, wherein the operations further comprise:
receiving a request to synchronize subtitle text with the audiovisual content prior to retrieving the first file and the second file, wherein the request comprises an identification comprises an identification of the audiovisual content and a desired subtitle language;
extracting, via natural language processing techniques, a first set of utterances from the first file and a second set of utterances from the second file, wherein each utterance from the first set of utterances is associated with a sentence from the first set of captions, and each utterance from the second set of utterances is associated with a sentence from the second set of captions, wherein at least one human translator generated the first set of captions by translating dialog from the audiovisual content into the desired language, and wherein an automated speech recognition (ASR) tool and a machine translation service generated the second set of captions by detecting and translating the dialog from the audiovisual content into the desired content; and
converting, via a massive language text embedding model the first set of utterances into the first set of embeddings and the second set of utterances into the second set of embeddings.

13. The non-transitory computer-readable medium of claim 11, wherein comparing the first set of embeddings and the second set of embeddings comprises:
determining cosine distance values between each embedding of the first set of embeddings and each embedding of the second set of embeddings;
generating a time-ordered matrix comprising the cosine distance values, wherein each row of the matrix is associated with a respective embedding from the first set of embeddings and ordered based off of a respective time interval associated with the respective embedding from the first set of embeddings, and each column of the matrix is associated with a respective embedding from the second set of embeddings and ordered based off of a respective time interval associated with the respective embedding from the second set of embeddings;
generating a plurality of pathways traversing the matrix, wherein each pathway of the plurality of pathways begins in an upper left-hand corner of the matrix and terminates in a bottom right-hand corner of the matrix;
determining a score for each pathway of the plurality of pathways based on a summation of cosine distance values associated with each entry of the matrix comprising the respective pathway;
determining an optimal pathway of the plurality of pathways based on the score for each pathway of the plurality of pathways, wherein the optimal pathway is associated with the minimum score; and
determining the level of similarity between the first set of embeddings and the second set of embeddings based on the optimal pathway, wherein a greater level of similarity between the first set of embeddings and the second set of embeddings is associated with a greater level of synchronicity between the first file and the audiovisual content.

14. The non-transitory computer-readable medium of claim 13, wherein one or more columns of the matrix are pruned based on the respective cosine distance values exceeding a threshold value associated with an acceptable level of similarity.

15. The non-transitory computer-readable medium of claim 13, wherein the operations further comprise generating a suggested change to a time interval of one or more captions of the first set of captions based on the optimal pathway.

16. The non-transitory computer-readable medium of claim 15, wherein the report is displayed via a graphical user interface (GUI), and wherein the report comprises one or more selectable options indicative of a command to approve the first set of captions as the subtitle text, implement the suggested change to a time interval of one or more captions of the first set of captions, review a time interval of the audiovisual content with one or more captions of the first set of captions displayed, or any combination thereof.

17. A method comprising:
retrieving a first file associated with audiovisual content from a first database, wherein the first file comprises a first set of captions associated with the audiovisual content, wherein each caption of the first set of captions comprises a time interval defining when each caption is provided during display of the audiovisual content;
retrieving a second file from a second database, wherein the second file comprises a second set of captions associated with the audiovisual content, wherein each caption of the second set of captions comprises a time interval defining when each caption is provided during display of the audiovisual content;
comparing the first file and the second file to determine a level of similarity between the first set of captions and the second set of captions to determine a level of synchronicity between the first file and the audiovisual content; and
generating a report based on the level of similarity between the first set of captions and the second set of captions.

18. The method of claim 17, wherein comparing the first file and the second file comprises:
extracting, via natural language processing techniques, a first set of utterances from the first file and a second set of utterances from the second file;
converting, via a massive language text embedding model, the first set of utterances into a first set of embeddings and the second set of utterances into a second set of embeddings, wherein the first set of embeddings and the second set of embeddings comprise multidimensional vector representations of text;
determining geometric measurement values indicative of the level of similarity between the first set of embeddings and the second set of embeddings;
generating a time-ordered matrix comprising the geometric measurements, wherein each row of the matrix is associated with a respective embedding from the first set of embeddings and ordered based off of a respective time interval associated with the respective embedding from the first set of embeddings, and each column of the matrix is associated with a respective embedding from the second set of embeddings and ordered based off of a respective time interval associated with the respective embedding from the second set of embeddings;
generating a plurality of pathways traversing the matrix, wherein each pathway of the plurality of pathways begins in an upper left-hand corner of the matrix and terminates in a bottom right-hand corner of the matrix;
determining a score for each pathway of the plurality of pathways based on a summation of geometric measurement values associated with each entry of the matrix comprising the respective pathway;
determining an optimal pathway of the plurality of pathways based on the score for each pathway of the plurality of pathways; and
determining the level of similarity between the first set of embeddings and the second set of embeddings based on the optimal pathway, wherein a greater level of similarity between the first set of embeddings and the second set of embeddings is associated with a greater level of synchronicity between the first file and the audiovisual content.

19. The method of claim 18, comprising generating a suggested change to a time interval of one or more captions of the first set of captions based on the optimal pathway.

20. The method of claim 19, wherein the report is displayed via a graphical user interface (GUI), and wherein the report comprises one or more selectable options indicative of a command to approve the first set of captions as the subtitle text, implement the suggested change to a time interval of one or more captions of the first set of captions, review a time interval of the audiovisual content with one or more captions of the first set of captions displayed, or any combination thereof.
